(19) United States
(12) Patent Application Publication
(10) Pub. No.: US 2025/0172105 A1
(43) Pub. Date: May 29, 2025

(54) INTERNAL COMBUSTION ENGINE

(71) Applicant: ISUZU MOTORS LIMITED, Yokohama-shi (JP)

(72) Inventor: Takuro MITA, Fujisawa-shi (JP)

(21) Appl. No.: 18/891,230

(22) Filed: Sep. 20, 2024

(30) Foreign Application Priority Data
Nov. 29, 2023 (JP) 2023-201353

(51) Int. Cl. F02F 3/10; F01M 11/02; F16J 9/20

(52) U.S. Cl. CPC F02F 3/10; F01M 11/02; F16J 9/20; F01M 2011/022

(57) ABSTRACT

An internal combustion engine includes a piston, a cylinder that has a sliding surface on which the piston slides, and a piston pin that connects the piston and a connecting rod. The sliding surface has a shape in which the inner diameter of a central portion in the axial direction is larger than the inner diameter of an upper end portion, and the center of the piston pin is located at the center of the piston.

### CROSS-REFERENCE TO RELATED APPLICATIONS

The present application claims priority to Japanese Patent Applications number 2023-201353, filed on Nov. 29, 2023 contents of which are incorporated herein by reference in their entirety.

### BACKGROUND OF THE INVENTION

The present disclosure relates to an internal combustion engine. A piston of an internal combustion engine is connected to a connecting rod by a piston pin. The center of the piston pin is offset from the center of the piston in order to reduce the impact force that the skirt portion of the piston exerts on a sliding surface of the cylinder when the piston moves up and down (see Japanese Unexamined Patent Application Publication No 2017-223333).

However, when the center of the piston pin is offset from the center of the piston, a force with which the piston is pressed against the sliding surface of the cylinder increases. This increases the frictional force and shortens the expansion period of the piston, resulting in a decrease in work efficiency of the internal combustion engine.

### BRIEF SUMMARY OF THE INVENTION

The present disclosure focuses on this point, and its object is to reduce the frictional force when a piston slides on a sliding surface and to prevent a decrease in work efficiency of an internal combustion engine.

One aspect of the disclosure provides an internal combustion engine including: a piston; a cylinder that has a sliding surface on which the piston slides; and a piston pin that connects the piston and a connecting rod, wherein the sliding surface has a shape in which an inner diameter of a central portion, which is central in an axial direction, is larger than an inner diameter of an upper end portion near a top dead center of the piston, and a center of the piston pin is located at a center of the piston.

### BRIEF DESCRIPTION OF THE DRAWINGS

FIG. 1 is a schematic view showing a configuration of an internal combustion engine 1.

FIG. 2 is a schematic view for explaining a thrust region and an anti-thrust region of a cylinder 12.

FIG. 3 is a schematic view showing the shape of a sliding surface 13 of the cylinder 12.

FIG. 4 is a schematic view for explaining a relationship between a piston 30 and the sliding surface 13 in the present embodiment.

FIG. 5 is a schematic view for explaining a comparative example.

FIG. 6 is a schematic view showing a configuration of the piston 30.

FIG. 7 is a cross-sectional view taken along a line I-I of FIG. 6.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Outline of an Internal Combustion Engine

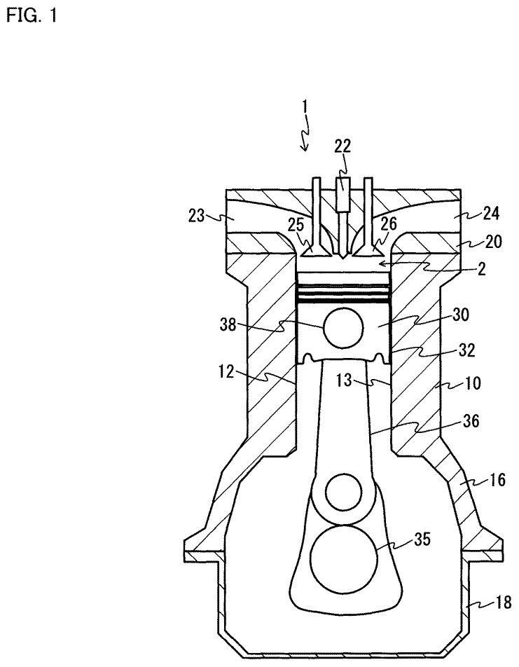

FIG. 1 is a schematic view showing a configuration of an internal combustion engine 1. The internal combustion engine 1 is a direct injection engine, for example. The internal combustion engine 1 includes a cylinder block 10, a cylinder head 20, and a piston 30.

The cylinder block 10 includes a cylinder 12 that houses the piston 30 in a manner allowing the piston 30 to reciprocate, and a crankcase 16 that houses a crankshaft 35. The cylinder block 10 has a configuration in which the cylinder 12 and the crankcase 16 are integrated. An oil pan 18 that reserves lubricating oil is attached to the crankcase. The cylinder 12 has a sliding surface 13 on which the piston 30 slides.

The cylinder head 20 is provided to an upper portion of the cylinder block 10. The cylinder head 20 is fixed to the cylinder block 10 with bolts. The cylinder head 20 includes an injector 22, an intake port 23, an exhaust port 24, an intake valve 25, and an exhaust valve 26. The injector 22 injects fuel into a combustion chamber 2 defined by a top surface of the piston 30, the sliding surface 13 of the cylinder 12, and the cylinder head 20. The intake port 23 is an intake port for introducing fresh air into the combustion chamber 2. The exhaust port 24 is an exhaust port for discharging exhaust gas from the combustion chamber 2. The intake valve 25 opens and closes to introduce fresh air from the intake port 23 into the combustion chamber 2. The exhaust valve 26 opens and closes to guide the exhaust gas from the combustion chamber 2 into the exhaust port 24.

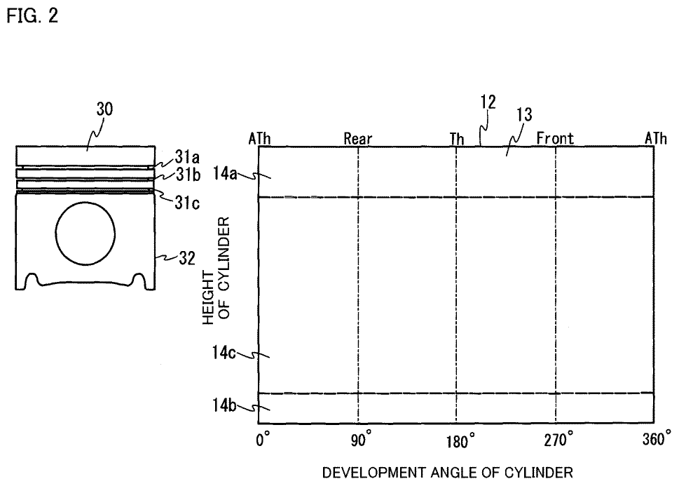

When the piston 30 reciprocates between a top dead center and a bottom dead center, the piston 30 slides over the sliding surface 13 of the cylinder 12. The lubricating oil is supplied to the sliding surface 13 to form an oil film. A plurality of piston rings 35 are provided to an outer periphery of an upper portion of the piston 30 in order to seal in combustion gas and maintain the oil film at a predetermined thickness. A ring member is provided in each of a plurality of ring grooves 31a, 31b, and 31c (see FIG. 2) formed on an outer peripheral surface of the piston 30. The ring member provided in the ring groove 31c is an oil ring that scrapes off the lubricating oil adhering to the sliding surface 13.

The piston 30 has a piston pin 38. The piston pin 38 connects the piston 30 and a connecting rod 36. The connecting rod 36 connects the piston 30 and the crankshaft 35, and converts reciprocating motion of the piston 30 into rotational motion of the crankshaft 35. In the present embodiment, the center of the piston pin 38 is located at the center of the piston 30.

A skirt portion 32 is provided to a lower portion of the piston 30. When the piston 30 reciprocates between the top dead center and the bottom dead center, the skirt portion 32 of the piston 30 is pressed against the sliding surface 13 of the cylinder 12. The sliding surface 13 of the cylinder 12 includes a thrust region against which the skirt portion 32 is pressed when the piston 30 descends from the top dead center to the bottom dead center, and an anti-thrust region against which the skirt portion 32 is pressed when the piston 30 ascends from the bottom dead center to the top dead center.

FIG. 2 is a schematic view for explaining the thrust region and the anti-thrust region of the cylinder 12. In FIG. 2, the cylinder 12 that has been rolled out in a plane, as a development view, is shown for convenience of explanation. The piston 30 shown in the upper left part of FIG. 2 is positioned at the top dead center. The horizontal axis of the development view of the cylinder 12 represents development angles of the cylinder 12, and the vertical axis represents the heights of the cylinder 12. In FIG. 2, “Th” means a thrust side, “ATh” means an anti-thrust side, “Front” means a front side of the piston 30, and “Rear” means a rear side of the piston 30.

A position with a development angle of 180° in FIG. 2 is a center position of the thrust region in a circumferential direction, and a position with a development angle of 0° is a center position of the anti-thrust region in the circumferential direction. The thrust region is a region within a predetermined angle range around the development angle of 180° (e.g., a range from 135° to 225°). The anti-thrust region is a region within a predetermined angel range around the development angle of 0° (360°) (e.g., ranges from 0° to 45° and from 315° to 360°).

### Details of the Sliding Surface of the Cylinder

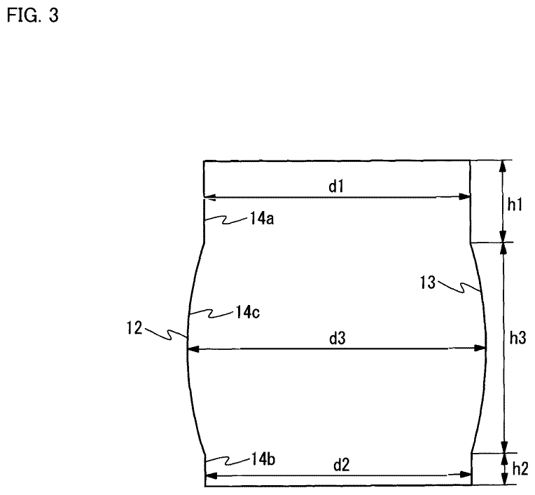

FIG. 3 is a schematic view showing the shape of the sliding surface 13 of the cylinder 12. The shape of the sliding surface 13 shown in FIG. 3 is the shape of a longitudinal section of the cylinder 12. FIG. 3 shows a difference between the inner diameter of a central portion 14c and the inner diameter of an upper end portion 14a (lower end portion 14b) to be larger than it actually is, for convenience of explanation.

The cylinder 12 is a cylindrical cylinder bore, and the sliding surface 13 is an inner wall surface of the cylinder. As shown in FIG. 3, the sliding surface 13 has a barrel shape with a bulge at the center in an axial direction of the cylinder 12. The sliding surface 13 includes the upper end portion 14a, the lower end portion 14b, and the central portion 14c.

The upper end portion 14a is a region near one axial end (upper end side) of the cylinder 12 (in other words, in a sliding direction of the piston 30) (see FIG. 2). The upper end portion 14a faces the entire outer peripheral surface of the piston 30 when the piston 30 is positioned at the top dead center.

The lower end portion 14b is a region near the other axial end (lower end side) of the cylinder 12 (see FIG. 2), and faces the entire outer peripheral surface of the piston 30 when the piston 30 is positioned at the bottom dead center. An inner diameter d2 of the lower end portion 14b is the same as an inner diameter d1 of the upper end portion 14a. However, the embodiment is not limited thereto, and the inner diameter d2 of the lower end portion 14b may be different from the inner diameter d1 of the upper end portion 14a.

The central portion 14c is a region between the upper end portion 14a and the lower end portion 14b in the axial direction of the cylinder 12 (see FIG. 2). The central portion 14c may contact the skirt portion 32 of the piston 30 when the piston 30 reciprocates between the top dead center and the bottom dead center.

An inner diameter d3 of the central portion 14c is larger than the inner diameters of the ends of the sliding surface 13 in the axial direction (that is, the inner diameter d1 of the upper end portion 14a and the inner diameter d2 of the lower end portion 14b). As a result, the sliding surface 13 has a barrel shape with a bulge at the center in the axial direction. Since the inner diameter d1 of the upper end portion 14a is smaller than the inner diameter d3, a gap between the skirt portion 32 and the upper end portion 14a can be made smaller. As a result, the impact force when the skirt portion 32 slides on the upper end portion 14a can be reduced. On the other hand, since the inner diameter d3 of the central portion 14c is large, a gap between the skirt portion 32 and the central portion 14c can be made larger when the piston 30 moves between the top dead center and the bottom dead center. Therefore, the frictional force when the skirt portion 32 slides on the central portion 14c can be reduced. The inner diameter d3 of the central portion 14c is larger than the inner diameter d1 of the upper end portion 14a by 0.05% to 0.3%, for example.

In the above description, the inner diameter d3 of the central portion 14c is larger than the inner diameter d2 of the lower end portion 14b, but the embodiment is not limited thereto. For example, the inner diameter d2 of the lower end portion 14b may be equal to or larger than the inner diameter d3 of the central portion 14c. Also in this case, since the gap between the skirt portion 32 and the central portion 14c can be made larger, the frictional force when the skirt portion 32 slides on the central portion 14c can be reduced.

The central portion 14c is convexly curved between the upper end portion 14a and the lower end portion 14b. Specifically, as shown in FIG. 3, the central portion 14c is curved in an arc shape between the upper end portion 14a and the lower end portion 14b. The central portion 14c may be curved at a predetermined curvature. The central portion 14c is connected between the upper end portion 14a and the lower end portion 14b without a level difference.

A length h3 of the central portion 14c in the axial direction is larger than a length h1 of the upper end portion 14a in the axial direction and a length h2 of the lower end portion 14b in the axial direction. Specifically, the length h3 of the central portion 14c in the axial direction is greater than the sum of the length h1 of the upper end portion 14a in the axial direction and the length h2 of the lower end portion 14b in the axial direction. In this way, the central portion 14c in which the gap with the skirt portion 32 becomes larger can be provided in a wide range in the axial direction, and the frictional force acting on the central portion 14c from the skirt portion 32 can be reduced.

The length h1 of the upper end portion 14a in the axial direction is greater than the length h2 of the lower end portion 14b in the axial direction. In this case, an area of the upper end portion 14a, which is narrower than the central portion 14c, becomes larger, allowing for a reduction in the amount of rocking of the piston 30 near the top dead center. The present embodiment is not limited to this, and as another example, the length h1 of the upper end portion 14a in the axial direction may be the same as the length h2 of the lower end portion 14b in the axial direction.

It has been known that offsetting the center of the piston pin 38 from the center of the piston 30 reduces the impact force acting on the sliding surface 13 (specifically, a central portion in the axial direction of the sliding surface 13) from the skirt portion 32 during the expansion stroke. In contrast, in the present embodiment, the center of the piston pin 38 is located at the center of the piston 30 (not offset), and the sliding surface 13 has a barrel shape with a bulging central portion 14c.

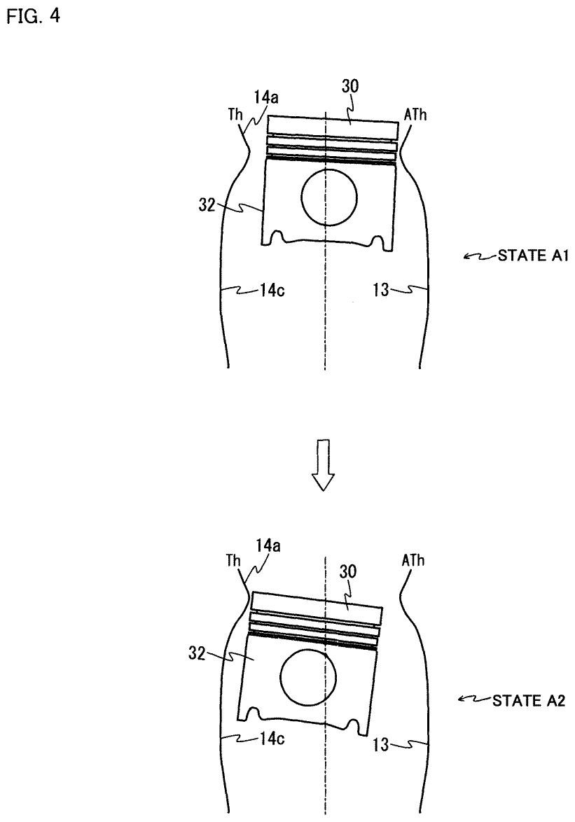

FIG. 4 is a schematic view for explaining a relationship between the piston 30 and the sliding surface 13 in the present embodiment. In FIG. 4, the shape of the sliding surface 13 is deformed due to temperature rise of the cylinder block 10 caused by combustion in the internal combustion engine 1, fastening force of the bolts for fixing the cylinder block 10 and the cylinder head 20, and the like. In addition, State A1 in FIG. 4 indicates the piston 30 positioned at the top dead center, and State A2 indicates the piston 30 during its descent. In the present embodiment, since the sliding surface 13 has the barrel shape, the gap between the skirt portion 32 and the central portion 14c becomes larger as shown in State A2, and the frictional force that the skirt portion 32 exerts on the central portion 14c during the compression stroke and the expansion stroke can be reduced.

Further, in the present embodiment, since the inner diameter of the upper end portion 14a is smaller than the inner diameter of the central portion 14c, as shown in State A1 of FIG. 4, the amount of rocking (tilting) of the piston 30 near the top dead center is reduced. Therefore, when the piston 30 with a smaller amount of rocking moves from the top dead center to the bottom dead center (expansion stroke), the skirt portion 32 is more likely to make parallel contact with the central portion 14c, as shown in State A2, and thus the impact force that the skirt portion 32 exerts on the central portion 14c (specifically, the thrust region Th of the sliding surface 13) can be reduced. As described above, in the present embodiment, even when the center of the piston pin 38 is not offset from the center of the piston 30, since a distance between the skirt portion 32 and the central portion 14c is increased, the impact force acting on the sliding surface 13 from the skirt portion 32 can be reduced.

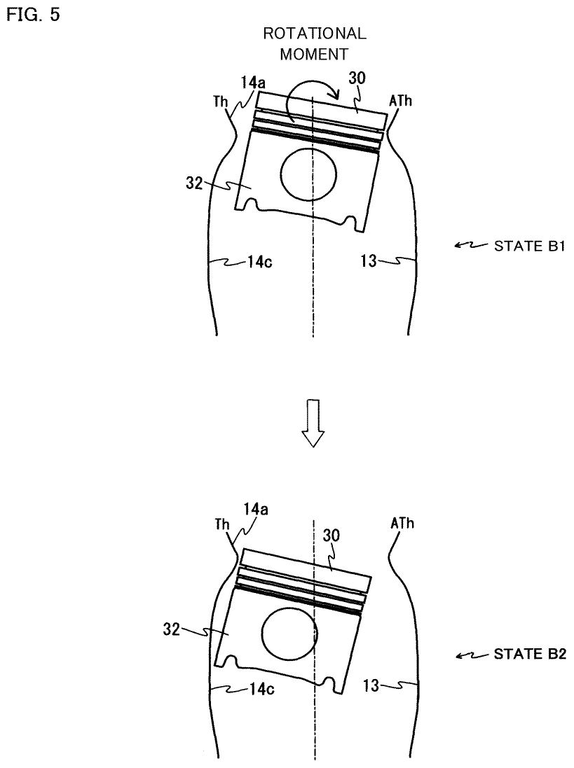

FIG. 5 is a schematic view for explaining a comparative example. In the comparative example, the center of the piston pin 38 is offset from the center of the piston 30. When the center of the piston pin 38 is offset, as shown in State B1, a force with which the piston 30 is pressed against the sliding surface 13 by the rotational moment when the piston 30 reciprocates increases. This increases the friction force and shortens the expansion period of the piston 30, resulting in a decrease in work efficiency of the internal combustion engine 1. Further, when the piston 30 located at the top dead center is positioned at the top dead center in an inclined state, combustion gas in the combustion chamber easily flows between the piston 30 and the sliding surface 13, increasing the soot that accumulates on the outer peripheral surface (specifically, a top land) of the piston 30. In contrast, in the present embodiment, since the center of the piston pin 38 is not offset, the frictional force when the piston 30 slides on the sliding surface 13 can be reduced, and the shortening of the expansion period can be prevented, thereby preventing a decrease in work efficiency of the internal combustion engine 1. In addition, as shown in State A2 of FIG. 4, since it is possible to prevent an increase in the inclination of the piston 30 positioned at the top dead center, it is possible to prevent accumulation of soot on the outer peripheral surface of the piston 30.

In the above description, the sliding surface 13 has the barrel shape shown in FIG. 3 as an example, but in consideration of the influence of the temperature rise of the cylinder block 10, the fastening force of the bolts for fixing the cylinder block 10 and the cylinder head 20, and the like, the sliding surface 13 may have a barrel shape when the internal combustion engine 1 is in operation. Further, in the above description, the cross section of the sliding surface 13 is a circle, but the embodiment is not limited thereto. For example, the sliding surface 13 may be an ellipse whose major axis is the thrust region and the anti-thrust region. Since the skirt portion 32 of the piston 30 slides in the thrust region and the anti-thrust region of the sliding surface 13, making the sliding surface 13 elliptical makes it easier to reduce the frictional force that the skirt portion 32 exerts on the sliding surface 13.

### Configuration of the Skirt Portion of the Piston

As described above, when the sliding surface 13 has the barrel shape, the gap between the central portion 14c of the sliding surface 13 and the skirt portion 32 becomes larger, and the lubricating oil is easily held on the surface of the skirt portion 32. In particular, as described below, since the present embodiment has a configuration in which the lubricating oil scraped off by the oil ring, which is the ring member, can be supplied to the skirt portion 32, the lubricating oil can be easily held in the skirt portion 32. When the lubricating oil is held in the skirt portion 32, it is possible to reduce vibration and noise generated when the piston 30 reciprocates.

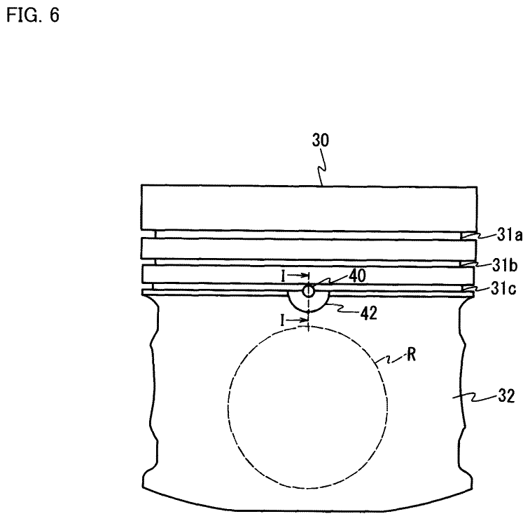

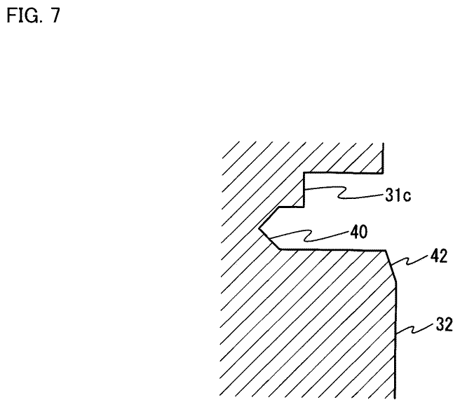

FIG. 6 is a schematic view showing a configuration of the piston 30. FIG. 7 is a cross-sectional view taken along a line I-I of FIG. 6. FIG. 6 shows the piston 30 obtained by rotating the piston 30 shown in FIG. 2 by 90 degrees in the circumferential direction. The piston 30 has a hole portion 40 on its outer peripheral surface. The lubricating oil scraped off by the ring member, which is the oil ring, flows into the hole portion 40. The hole portion 40 is provided at the center in the circumferential direction of an opposing portion (a first opposing portion) of the skirt portion 32 facing the thrust region of the cylinder 12. Specifically, the hole portion 40 is provided at a central upper portion of the first opposing portion in the circumferential direction.

The hole portion 40 is adjacent to the ring groove 31c. As shown in FIG. 7, the hole portion 40 is formed to have a predetermined depth from the outer peripheral surface of the piston 30. The depth of the hole portion 40 is greater than the depth of the ring groove 31c. However, the hole portion 40 is not a hole that penetrates entirely through the piston 30, but is a blind hole. Therefore, the lubricating oil scraped off by the ring member is easily held in the hole portion 40.

The lubricating oil that has flowed into and is held by the hole portion 40 flows out of the hole portion 40 when the piston 30 moves up and down. For example, the lubricating oil held in the hole portion 40 flows out to the surface of the skirt portion 32 when the piston 30 moves up and down. That is, the lubricating oil held in the hole portion 40 is supplied to the surface of the skirt portion 32. In particular, since the hole portion 40 is provided in the central upper portion of the first opposing portion in the circumferential direction, the lubricating oil held in the hole portion 40 can be easily supplied to a wide area of the first opposing portion. As a result, the lubricating oil held in the portion of the surface of the skirt portion 32 facing the thrust region increases.

The skirt portion 32 is located below the hole portion 40 in the up-and-down direction of the piston 30 and has a communication groove 42 that communicates with the hole portion 40. The communication groove 42 is located at an upper portion of the surface of the skirt portion 32. As shown in FIG. 7, the communication groove 42 is a groove formed so that the portion between the hole portion 40 and the skirt portion 32 is inclined. The communication groove 42 is a flow path through which the lubricating oil held in the hole portion 40 flows to the surface of the skirt portion 32 (specifically, a region R shown in FIG. 6). Therefore, providing the communication groove 42 enables the lubricating oil to be easily supplied to the region R of the skirt portion 32. The region R of the skirt portion 32 is a region that easily contacts the thrust region of the sliding surface 13 when the piston 30 descends.

Here, the shape of the communication groove 42 is a fan shape, as shown in FIG. 6. However, it is not limited thereto, and the communication groove 42 may have a triangular shape. In such a case where the communication groove 42 has a fan shape or a triangular shape, the width of the communication groove 42 narrows toward its distal end, and thus the lubricating oil in the communication groove 42 easily flows to the skirt portion 32.

In the present embodiment, the hole portion 40 is also provided at the center in the circumferential direction of an opposing portion (a second opposing portion) of the skirt portion 32 facing the anti-thrust region of the cylinder 12. Specifically, the hole portion 40 is provided at a central upper portion of the second opposing portion in the circumferential direction. Further, the communication groove 42 that communicates with the hole portion 40 is provided. That is, the hole portion 40 and the communication groove 42 are provided at intervals of 180 degrees in the circumferential direction of the outer peripheral surface of the piston 30. In this way, the lubricating oil is supplied to the portion of the skirt portion 32 facing the thrust region and the portion of the skirt portion 32 facing the anti-thrust region. In other words, the lubricating oil is supplied to the portion of the skirt portion 32 that is likely to come into contact with the cylinder 12.

### Effects of the Embodiment

In the internal combustion engine 1 of the above-described embodiment, the sliding surface 13 of the cylinder 12 has a shape in which the inner diameter of the central portion 14c is larger than the inner diameter of the upper end portion 14a. The center of the piston pin 38 is located at the center of the piston 30. As a result, the gap between the skirt portion 32 and the central portion 14c of the sliding surface 13 becomes larger, and the frictional force that the skirt portion 32 exerts on the central portion 14c during the compression stroke and the expansion stroke can be reduced. In addition, since the center of the piston pin 38 is located at the center of the piston 30, the shortening of the expansion period of the piston 30 can be prevented, thereby preventing the decrease in work efficiency of the internal combustion engine 1.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. An internal combustion engine comprising:
a piston;
a cylinder that has a sliding surface on which the piston slides; and
a piston pin that connects the piston and a connecting rod, wherein
the sliding surface has a shape in which an inner diameter of a central portion, which is central in an axial direction, is larger than an inner diameter of an upper end portion near a top dead center of the piston, and
a center of the piston pin is located at a center of the piston.

2. The internal combustion engine according to claim 1, wherein
the central portion of the sliding surface is convexly curved between the upper end portion and a lower end portion of the sliding surface near a bottom dead center of the piston.

3. The internal combustion engine according to claim 1, wherein
the central portion of the sliding surface is curved in an arc shape between the upper end portion and a lower end portion of the sliding surface near a bottom dead center of the piston.

4. The internal combustion engine according to claim 1, wherein
the upper end portion faces an entire outer peripheral surface of the piston positioned at the top dead center.

5. The internal combustion engine according to claim 1, wherein
the sliding surface has a lower end portion near a bottom dead center of the piston, and the inner diameter of the central portion is larger than an inner diameter of the lower end portion.

6. The internal combustion engine according to claim 5, wherein
a length of the upper end portion in the axial direction is larger than a length of the lower end portion in the axial direction.

7. The internal combustion engine according to claim 1, wherein
the piston includes a skirt portion and a ring member that is provided on an outer peripheral surface of the piston and scrapes off lubricating oil adhering to the sliding surface,
the cylinder includes a thrust region against which the skirt portion is pressed when the piston descends,
the skirt portion includes a first opposing portion facing the thrust region, and
a hole portion having a predetermined depth into which the lubricating oil scraped off by the ring member flows is provided at a center in a circumferential direction of the first opposing portion.

8. The internal combustion engine according to claim 1, wherein
the piston includes a skirt portion and a ring member that is provided on an outer peripheral surface of the piston and scrapes off lubricating oil adhering to the sliding surface,
the cylinder includes an anti-thrust region against which the skirt portion is pressed when the piston ascends,
the skirt portion includes a second opposing portion facing the anti-thrust region, and
a hole portion having a predetermined depth into which the lubricating oil scraped off by the ring member flows is provided at the center of the second opposing portion in the circumferential direction.

9. The internal combustion engine according to claim 7, wherein
the lubricating oil that has flowed into and is held by the hole portion flows out to the skirt portion when the piston moves up and down.

10. The internal combustion engine according to claim 7, wherein
the skirt portion has a communication groove which is located below the hole portion in the up-and-down direction of the piston and communicates with the hole portion.
